(19) United States
(12) Patent Application Publication
(10) Pub. No.: US 2007/0174435 A1
(43) Pub. Date: Jul. 26, 2007

(54) Configuration of LAN hosts

(76) Inventors: Neil Philip Piercy, Royston (GB); Nicholas Dougall Johnson, London (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/709,453

(22) Filed: Feb. 21, 2007

Related U.S. Application Data
(62) Division of application No. 10/475,379, filed on Oct. 20, 2003.

(30) Foreign Application Priority Data
Apr. 24, 2001 (GB) 0110058.5

(51) Int. Cl. G06F 15/177

(52) U.S. Cl. 709/220

(57) ABSTRACT

A Local Area network is disclosed in which host specific configuration information, and in particular VSI, can be distributed. A network server is disclosed that is capable of supplying both network configuration information, including IP addresses, and VSI. This is used in addition to existing network servers. A relay agent is also supplied that is configured to add VSI to the network configuration information supplied by an existing network server. A network server is also disclosed that provides VSI only in response to DHCP INFORM requests.

This invention relates to distributing configuration information between hosts across Local Area Networks (LANs), especially for information which is specific to a particular kind of host and when more than one of such kind of host requiring information specific to it exists on the LAN.

When LANs were first created, each host on the LAN had to be manually configured with consistent information about its address on the network (which has to be unique within the network and consistent with the LAN network configuration), the LAN and the wider network configuration and servers. Most of this information, apart from the individual network address of each host, is identical in all hosts within a LAN. This was clearly a large burden both at installation time, and for ongoing maintenance if the common information about the LAN or wider network configuration or servers changed.

To address this problem for hosts based on the almost-universal Internet Protocol (IP), the Internet community developed a standard method, called the Dynamic Host Configuration Protocol (DHCP), of allowing many hosts to be automatically configured with their IP address as well as with standard LAN and basic network server information, such as the IP Subnet Mask in use on that LAN, the default gateway address to be used to contact other LANs, and the address or addresses of the Domain Name Server(s) (DNS) in use within the network. The current version of this protocol is specified in the Internet Engineering Task Force (IETF) document RFC 2131.

A network using DHCP for its host configuration requires the configuration of a DHCP server with the required network configuration information and a pool of IP addresses for the hosts. Each host which wishes to be automatically configured runs a DHCP client (typically as they power up), which broadcasts a request for configuration on the LAN (a DHCPDISCOVER message). Any DHCP server which receives this broadcast may respond (with a DHCPOFFER message), supplying a unique IP address for the host to use for a specified “Lease Time”, together with the common information about the network. After accepting the offer in another message exchange, the host may then configure its network interface with the supplied IP address and network configuration information, and is able to use the main network services. On-going updates to the LAN configuration may also be made to the DHCP server, and the hosts will discover the changes and reconfigure themselves the next time they power up or when they try to renew the leased IP address towards the end of their lease time.

All hosts on a LAN have a fixed “Hardware Address” (a.k.a. “MAC Address”, or on an Ethernet LAN, “Ethernet Address”), and the server uses this to ensure that the IP address offered to each host is not offered to any other host for the duration of the lease. This Hardware Address may also be used by the server to provide host-specific information, if it is configured so to do, using the address as the “key” to find the correct unique information for the host. For example, it is a common requirement for some hosts, typically servers, to be required to have a well-known and fixed IP address so that other hosts can contact them to obtain their services. These hosts may still use the DHCP method of obtaining their configuration information by configuring the DHCP server to always offer the required IP address to (and only to) DHCP requests which contain the specific hardware address of the server.

In some networks it is inconvenient for the administrators to configure the DHCP server with the fixed addresses for such hosts as described above, and it is more convenient to configure the host manually with its IP address (which is not in the pool of IP addresses which the DHCP server is allowed to allocate). Generally however the administrator does not wish to have to manually configure all the network-specific (rather than host-specific) configuration information manually for the maintenance reasons described above. The DHCP protocol has been designed to allow such hosts to still receive the common (or missing parts of) network configuration from the DHCP server without receiving an IP address lease. Each host sends (usually broadcast) a DHCPINFORM message, and any server which receives this message responds by giving the normal network configuration information, but not issuing a new IP address from its available pool.

The DHCP protocol allows for a large number of “options” to be included in the configuration supplied to each host. These options cover a wide range of possible information which a LAN administrator may wish to supply to all the hosts within the LAN, such as the IP addresses of servers for some commonly used services (e.g. servers running the Network Time Protocol (NTP) to allow hosts to synchronise their clocks).

The DHCP protocol also includes a pair of options, the Vendor Class Identifier (VCI) and the Vendor Specific Information (VSI) options, which may be used to distribute a particular set of information (the VSI) to all clients of a particular type (as identified by the value in the VCI). The hosts running the DHCP client includes a VCI option in its requests, and a DHCP server which has been configured to understand the particular information required by the class of host identified by the VCI value may respond to the host including the VSI with the configured information. The use of VCI/VSI with normal PC hosts is rare and not particularly relevant, but it is useful for embedded systems (i.e. systems which have little or no user interface, e.g. LAN-based radio basestations). Although the options include the terms “Vendor Class” and “Vendor Specific”, they are more normally used for “device class” and “device specific” configuration. The VSI may include redundant information (e.g. a list of several possible servers which may provide a service), from which the host may select or try only one or more, as well as required information.

Even despite the above flexibility of DHCP usage and server configuration, there are a number of scenarios with which the standard use of DHCP does not cope, or only copes in a non-ideal manner. These include:

1. Many DHCP servers do not allow for all the DHCP options to be configured, and specifically do not support the selection of VSI based on VCI from the client.

2. DHCP servers are usually administered by the main network administration staff in order to maintain consistent policy, whereas much of the host-specific information may not impact those policies and is dictated by the end use the host is intended for.

The consequence of these is that it is sometimes not feasible to configure the DHCP server with the VCI/VSI support.

It would therefore be advantageous to provider a LAN having an improved ability to distribute device specific configuration to nodes connected together by the LAN. This is preferably achieved using DHCP.

According to the present invention there is provided a Local Area Network comprising:

a first set of network hosts configured to issue a first request for network configuration information, said first request utilising a configuration protocol;

a second set of network hosts configured to issue a second request for both said network configuration information and host specific configuration information, said second request utilising said configuration protocol;

a first set of network configuration servers configured to supply said network configuration information utilising said configuration protocol in response to receiving one of said first and second requests; and

a second set of network configuration servers configured to supply both said network configuration information and said host specific configuration information utilising said configuration protocol only in response to receiving said second request from one of said second set of network hosts.

Preferably, said second set of network hosts are configured to ignore said network configuration information supplied by said first set of network servers.

Alternatively or additionally, said network configuration information includes network address to be allocated to said network hosts.

Preferably, wherein said first set of network configuration servers are configured to allocate said network address from a first set of network addresses and said second set of network configuration servers are configured to allocate said network address from a second set of network address, said first set and said second set of network addresses being mutually exclusive.

According to the present invention there is also provided a Local Area Network comprising:

a network host configured to issue a request for network configuration information and host specific configuration information, said request utilising a configuration protocol;

a network server configured to supply said network configuration information, utilising said configuration protocol, to said network host, in response to receiving said request; and

a host configuration unit configured to supply said host specific configuration information to said network host, utilising said configuration protocol,

wherein said host configuration unit also receives said request and forwards said request to said network server, said network server also supplies said network configuration information to said host configuration unit in response to receiving said forwarded request, and wherein said host configuration unit is further configured to supply both said received network configuration information and said host specific configuration information to said network host.

Preferably, said network configuration information includes network address to be allocated to said network hosts.

According to the present invention there is further provided a Local Area Network comprising:

at least one network host configurable with network configuration information; and

at least one host network server:

configured to supply host specific configuration information utilising a configuration protocol to said or each network host only in response to a first request issued by said network host after said network host has been configured with said network configuration information.

Preferably, said first request includes a request for a network address. Additionally, only said or each first network server is configured to allocate a network address to a network host in response to said first request.

Additionally or alternatively, only said or each second network server is configured to supply said host specific configuration information.

Preferably, for all embodiments of the present invention, said configuration protocol comprises a Dynamic Host Configuration Protocol and said host specific configuration information comprises Vendor Specific information.

The present invention will now be described, by way of example, with reference to the accompanying drawings, in which:

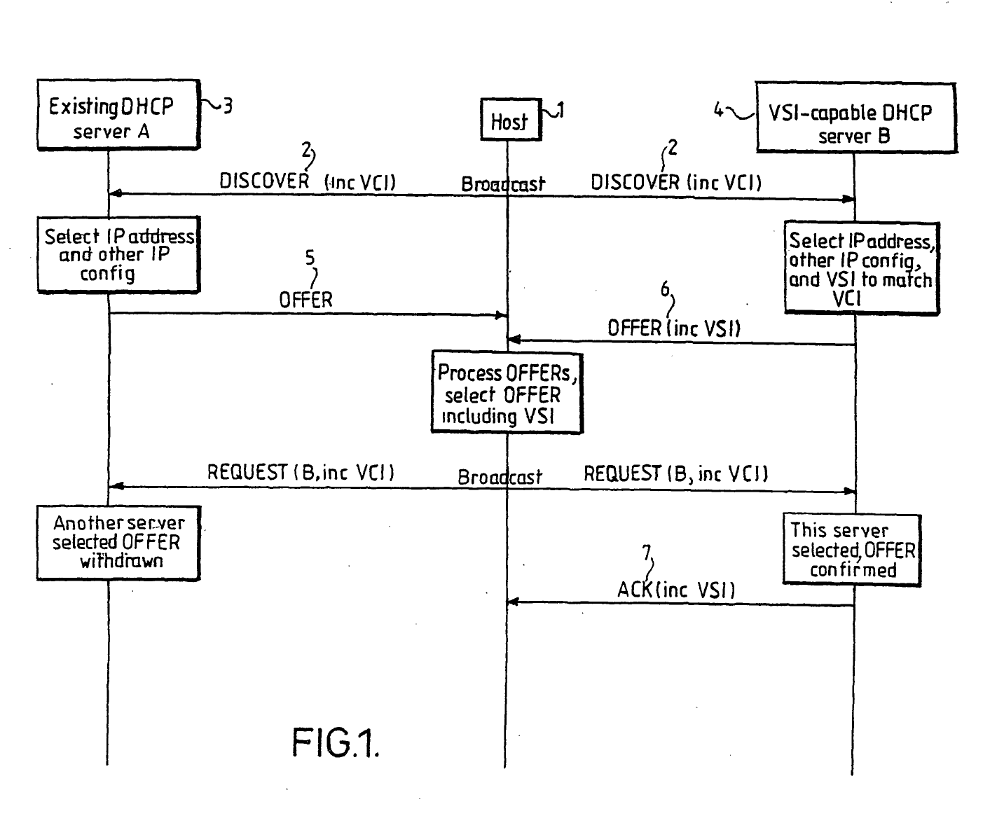

FIG. 1 schematically illustrates the use and operation of a VSI-capable DHCP server;

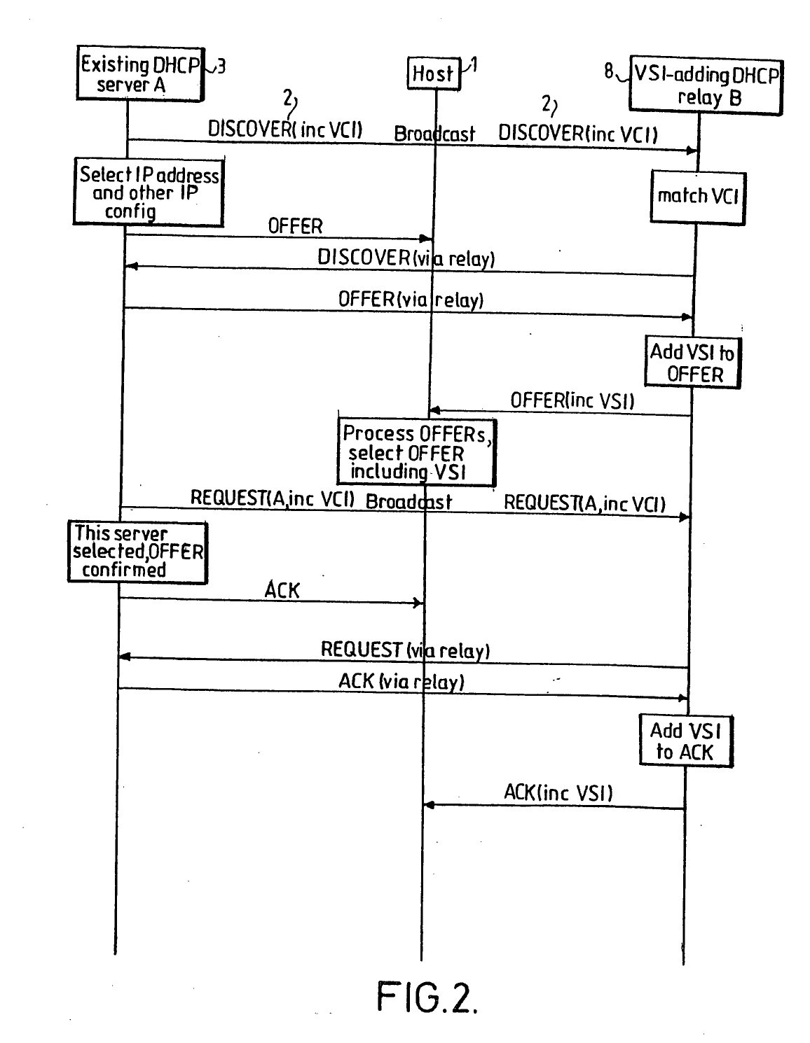

FIG. 2 schematically illustrates the use and operation of a VSI-adding DHCP relay agent; and

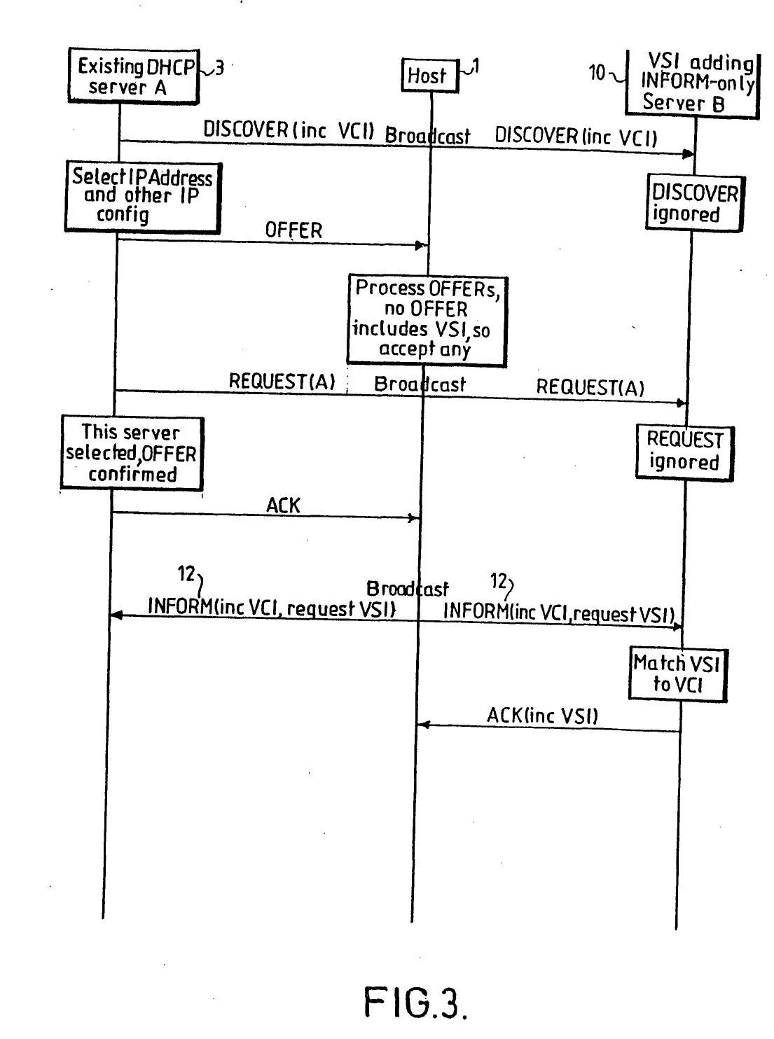

FIG. 3 schematically illustrates the use and operation of a DHCP INFORM only server.

This invention is applicable to enhancing the “plug-and-play” capabilities of ally LAN-based equipment which needs, either optionally or as mandatory, more configuration than provided by a normally configured DHCP server, especially if system administration policy requires that all IP addresses dynamically allocated are allocated by the existing normal DHCP servers.

There are several possible embodiments of the invention, any one of which or all of which may coexist, depending on the most convenient to establish and administer.

One embodiment of the invention uses a customised VCI/VSI-capable DHCP server in parallel with any existing standard DHCP servers. The VCI/VSI-capable DHCP server is configured to only serve IP addresses to those requests which include a VCI for which it has relevant VSI. A DHCP host used according to the invention is similarly built to only (or preferentially) accept responses from DHCP servers which include the VSI (and optionally VCI). The consequence of this is that the set of VCI/VSI-capable DHCP hosts are served by the VSI/VCI-capable DHCP server, and the remaining DHCP hosts are served from the existing DHCP server(s). This is illustrated in FIG. 1. The DHCP host 1 firstly issues, or broadcasts, a DISCOVER command 2 including VCI that is received by both an existing DHCP server 3 and a VSI capable server 4. Both servers respond by selecting an IP address and other network configuration information, the VSI capable server 4 further matching VSI to the VCI. Both servers return their respective offers 5, 6 to the host 1. The host processes both offers and selects the offer including the VSI, supplied by the VSI capable server 4. The host 1 then broadcasts its acceptance of the offer including the VCI. The DHCP server 3 is thus notified that another server's offer has been accepted and withdraws its own offer, while the VSI capable server 4 acknowledges the acceptance of its offer with an acknowledgement 7.

This approach is novel but entirely conformant to the DHCP specifications. It does however have the disadvantages that the VCI/VSI capable DHCP server has to be configured with a set of DHCP server configuration which is consistent with any existing standard DHCP server information, and additionally has to have a set of IP addresses which it may lease to the VCI/VSI-capable hosts that must not be leased by any existing standard DHCP servers. Whilst the former disadvantage may be alleviated by the VCI/VSI capable DHCP server using the network configuration that it has received from any existing standard DHCP server in its responses to the hosts (thus ensuring consistency), the latter has no automated solution: the two servers must be configured with separate non-overlapping sets of IP addresses to serve.

A second embodiment of the invention, illustrated in FIG. 2, is to use a VCI/VSI-capable DHCP relay agent 8 (a.k.a. “BOOTP relay agent” or originally “BOOTP forwarding agent”). The relay agent receives the DISCOVER requests 2 from the DHCP host 1, and, according to the invention, if it includes the VCI, relays it to the DHCP server, modifying it according to the DHCP specification. The DHCP server replies to the host 1 with its configuration and IP address lease for the host, but also sends it back via the relay agent 8 as required by the DHCP specification. The VCI/VSI-capable DHCP relay agent 8 built according to the invention then adds the VSI to the response options from the normal DHCP server 3 and forwards it back to the DHCP host 1. Whilst the use of relay agents is already well-known, their use for this purpose is novel:

a. Relay agents normally only operate in place of a DHCP server on a LAN: if there is a DHCP server on the LAN there is no need for a relay agent, and the DHCP server receives the DHCP host's broadcast request directly, and responds directly to the host. In this novel usage there is both the DHCP server and the relay agent on the LAN: the server should still respond to the host directly, but should also respond to the relay agent (normally with the same information). The host will therefore receive both the direct response, and the response via the relay agent with the added VSI it requires.

b. Relay agents do not normally modify the information within the requests or response, except as required by the DHCP specification. A DHCP relay agent built according to this invention adds the VSI which corresponds to the VCI in the request.

The use of this embodiment using a DHCP relay agent to add the VSI has the advantage over the previously described embodiment that it avoids the need for the VCI/VSI-capable DHCP server/agent having to be configured with either the network configuration or with its own pool of IP addresses to lease. It must know the IP address of the DHCP server to which it forwards the requests, but it may determine this from its own usage of DHCP (as a host) within the network. It also greatly simplifies the VCI/VSI-capable server/agent: as a DHCP relay agent it does not need to maintain any records of IP address leases, IP address pools etc.

A third embodiment of the invention is to use a VCI/VSI-capable DHCPINFORM-only server this is illustrated in FIG. 3. A DHCP host 1 performs a DHCP exchange in the normal manner (optionally including the VCI and requesting the VSI, which may be supplied by either the normal DHCP server 3, or by one of the two embodiments of this invention described above), and accepts the normal offer of IP address and network configuration from a normal DHCP server, which does not include the VSI required. Once this has completed, a DHCP host built according to this invention which has not yet received the VSI attempts to obtain the VSI by broadcasting a DHCPINFORM 12, including the IP address already obtained, the VCI, and requesting the VSI. The VCI/VSI-capable DHCPINFORM-only server 10 built according to this invention will detect the VCI in the DHCPINFORM 12 and reply with the corresponding VSI. The normal DHCP server 3 may also respond (without the VSI option), but the DHCP host 1 built according to this invention will ignore this response as it should not alter the network configuration information which it already has from that server in the initial exchange, and does not include the VSI. This embodiment has the advantage that the VCI/VSI-capable DHCPINFORM-only server need only be configured with the VCI/VSI information, and, like the second embodiment above, has no need to maintain historical information on leased IP addresses or IP address pools.

The use of such DHCP host and DHCP relay or DHCPINFORM-only servers according to any of the above embodiments of the invention is not limited to their use to supply VSI based on VCI. There are several methods other than VCI by which a DHCP server or relay agent according to this invention may distinguish those DHCP hosts which it should serve, adding optional information which any existing DHCP servers may not be configured with (either due to lack of capability, for reasons of administrative domains, or for any other reason) and those which it should not. Other examples of information which the DHCP server or relay agent may use to distinguish those requests it should service include:

Hardware Address of the host any existing standard DHCP servers need not be configured with machine-specific details, but the DHCP server according to this invention may add machine-specific configuration options

Parameter Request List option: this option is used by a DHCP host to request the inclusion of specific options. A DHCP server or relay agent built according to this invention may detect options requested which it is configured to server which any existing standard DHCP servers are not.

Boot Server and/or Filename: these options may be included to request a generic boot server name and/or filename by a host from which it wishes to obtain its main operating code over the LAN from a TFTP server (see the IETF specification RFC 1350). A DHCP server or relay agent built according to this invention may detect these values, which it has been configured to recognise and respond with the actual TFTP server or filenames, whereas any existing standard DHCP servers are not so configured.

Similarly, other examples of information which the DHCP server or relay agent may provide which any existing DHCP servers are not configured to provide include:

Specific Options which it has been configured to provide in addition to those options provided by any existing DHCP servers, as requested by the DHCP host. For example, an NTP server may include a DHCP relay or DHCPINFORM-only server which adds its own IP address in an NTP server option if it detects that the DHCP host (either built according to the third embodiment of this invention, or a standard DHCP host if the NTP server is built according to second embodiment of this invention) has requested the NTP Server option in its Parameter Request List, and that the DHCP server has not supplied such an option.

Boot Server and/or Boot Filename.

Whilst the selective provision of such information and the presence of multiple DHCP servers is a standard part of the DHCP protocol, the automated manner in which the options are added to the response to the hosts without affecting the configuration or operation of the DHCP server is a novel aspect of this invention.

Another aspect of this invention is the combination of a VCI/VSI-capable DHCP relay agent (according to the second embodiment above) or of a DHCPINFORM-only server (according to the third embodiment above) together with a host which uses a VCI/VSI-capable DHCP host (either according to the invention, or not) in a single device. Once there is one such device on a LAN which has been configured (either according to this invention, or by any external means) with the VSI corresponding to its VCI, it may act as the DHCP relay agent or DHCPINFORM-only server according to this invention so as to supply the VSI (or part thereof) to other hosts running a DHCP client using the same VCI. In effect such hosts act as caches for this VSI option (or part thereof). A DHCP host which obtains the VSI in this manner may accumulate some or all of the responses from the DHCP servers, relays or DHCPINFORM-only servers so as to obtain as complete a set of information as possible, and make their own selections where such options exist.

One problem which such caching servers introduce is that as the number of caching servers within a single network increases, the number of responses to a single request also increases. This undesirable behaviour may however be controlled or reduced through the use of commonly-used random time before transmission (to ensure separation of the messages), and through the DHCP caching servers maintaining using the count of how many VCI/VSI responses it received it its initial DHCP host requests, and only responding as a caching server if this count is acceptable small, or as this number becomes larger, having a reducing probability of responding to any subsequent client requests.

The use of such DHCP client and DHCP relay or DHCPINFORM-only servers according to this aspect of the invention is not limited to their use to supply VSI. The options described above may be similarly cached by a combined DHCP client and relay agent or DHCPINFORM-only server built according to this invention.

A third aspect of this invention is the combination of a DHCP relay agent or DHCPINFORM-only server built according to this invention together with a TFTP server in a single device. If such a device receives a request from another DHCP host (either built according to this invention or not) for a boot server address, and it recognises through any means that the requesting device is a device which may use a boot image identical to its own, it may give to the requesting host its own address as that of the TFTP server which may supply the image. The host may then use this information, along with any other offers it receives from other DHCP servers, and elect to download its boot image from the offering TFTP sever and DHCP relay agent built according to this invention.

One possible means by which the DHCP servers built according to this invention may be configured with VSI/VCI information is through the use of a Smart Card, memory card or similar memory module. This allows the customization of the VSI/VCI information in a manner which does not require any user interface on the DHCP servers.

1-11. (canceled)

12. A Local Area Network comprising:
at least one network host configurable with network configuration information; and
at least one host network server configured to supply host specific configuration information utilizing a configuration protocol to said or each network host only in response to a first request issued by said network host after said network host has been configured with said network configured information.

13. A Local Area Network according to claim 12, further comprising at least one second network server configured to supply said network configuration information utilizing said configuration protocol in response to receiving a second request from said or each network host, wherein said second request is issued prior to said first request.

14. A Local Area Network according to claim 13, wherein said second request includes a request for a network address.

15. A Local Area Network according to claim 14, wherein only said or each second network server is configured to allocate a network address to a network host in response to said second request.

16. A Local Area Network according to claim 12, wherein only said or each first network server is configured to supply said host specific configuration information.

17. A Local Area Network according to claim 12, wherein said configuration protocol comprises a Dynamic Host Configuration Protocol.

18. A Local Area Network according to claim 17, wherein said host specific configuration information comprises Vendor Specific Information.
